(19) United States
(12) Patent Application Publication
(10) Pub. No.: US 2005/0233463 A1
(43) Pub. Date: Oct. 20, 2005

(54) Method and device for the detection of SF6 decomposition products

(75) Inventors: Nicola Dominelli, Coquitlam (CA); Ian Gordon Norman Wylie, Langley (CA); Keith Cheuklap Lee, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Powertech Labs Inc., Surrey (CA)

(21) Appl. No.: 11/103,583

(22) Filed: Apr. 12, 2005

Related U.S. Application Data
(60) Provisional application No. 60/561,910, filed on Apr. 14, 2004.

(51) Int. Cl. G01N 21/76

(52) U.S. Cl. 436/119; 422/52

(57) ABSTRACT

This invention is in the field of gas detection for sulphur hexafluoride (SF₆) gas decomposition products, particularly for the detection of thionyl fluoride (SOF₂) and sulphur dioxide (SO₂). The invention relates to a novel portable handheld instrument that can readily detect SOF₂, SF₄ and SO₂ in SF₆ gas filled electrical equipment and in air. An apparatus for detecting SF₆ decomposition products comprising: (a) an inlet for receiving SF₆ gas containing SOF₂ or SF₄; (b) A chamber connected to the inlet and containing a catalyst which converts SOF₂ or SF₄ into SO₂; and (c) an SO₂ detector connected downstream of the chamber.

### REFERENCE TO RELATED APPLICATION

This application claims the benefit of the filing date of U.S. provisional application Ser. No. 60/561,910, filed 14 Apr. 2004.

### FIELD OF THE INVENTION

This invention is in the field of gas detection for sulphur hexafluoride (SF₆) gas decomposition products, particularly for the detection of thionyl fluoride (SOF₂), sulphur tetrafluoride (SF₄) and sulphur dioxide (SO₂). The invention relates to a novel portable handheld instrument that can readily detect SOF₂, SF₄ and SO₂ in SF₆ gas filled electrical equipment, and in air.

### BACKGROUND OF THE INVENTION

Sulphur hexafluoride (SF₆) is a colorless, odorless, non-toxic and non-flammable gas. It has good dielectric and arc-quenching characteristics. These unique properties have made it a popular choice as a dielectric medium for high voltage equipment. Since its introduction in the 1950's, its popularity has grown to include circuit breakers, switches, current transformers, busbars, and cables. It has replaced flammable insulating oil in many applications allowing for the use of more compact gas insulated substations in dense urban areas.

During arcing, partial discharge or other abnormal operating conditions, some SF₆ is decomposed into highly reactive sulphur-fluorine compounds. Most of these primary decomposition products (such as SF₄, SF₂, S₂F₂, and F₂) will quickly react with other materials or impurities inside the equipment to form more stable secondary decomposition products (such as SOF₂, SO₂F₂, SO₂, COS, and HF). Even these more stable gases will eventually further react with moisture or metal oxides and may lead to corrosion of the equipment. In addition, many of these gases are highly toxic and pose a health issue to personnel performing maintenance, servicing or cleanup of the equipment.

One traditional method for the location of faults in gas-insulated-equipment was to briefly open the valve to the suspect enclosure and smell the gas. SF₆ decomposition products have a distinct acrid odour similar to that of rotten eggs but due to their toxic nature, this method of detection is discouraged.

Since the primary decomposition products are extremely short-lived in the equipment, the detection of secondary decomposition products has been more commonly used, with varying degrees of success. Prior disclosures and inventions are listed in the following:

U.S. Pat. No. 3,512,939, Hugi, 19 May 1970 (GB 1152754, FR 1553803, DE 1488860, CH 448259) discloses a device for determining the presence of harmful gaseous decomposition products of a sulphur hexafluoride (SF₆) filling for electrical apparatus such as transformers, encapsulated switchgear and gas-filled cables, comprising a receptacle arranged to be placed in communication with the sulphur hexafluoride filling, the receptacle containing a granular material containing OH ions such as activated alumina or magnesia which is dyed with a dyestuff which changes its color or color saturation with the pH value. The material exhibits a permanent and irreversible change in color or color saturation with the partial pressure of the gaseous contaminants as a result of their initial contact with the material. This is the technology usually used in indicator tubes.

U.S. Pat. No. 4,505,146, Miners, 19 Mar. 1985 (CA 1,201,767, issued 11 Mar. 1986 is the Canadian counterpart) describes the use of high voltage insulators that changes their resistance when exposed to decomposition products. Miners discloses a portable gas analyzer for detecting SF₆ decomposition products in electrical equipment to signal a warning before decomposition reaches the stage that the presence of the decomposition products causes degradation of the solid insulating materials used in the construction of the SF₆ equipment. The forewarning of the decomposition products anticipates costly breakdowns. The portable gas analyzer is based on the principle of non-destructive testing wherein the surface sensitivity of selected insulating materials which decrease rapidly when exposed to increasing concentrations of SF₆ decomposition products is measured.

The technique is further refined in DE 4133947, Rupprecht, 15 Apr. 1993, which describes the incorporation of the resistance measurement into a probe that could be installed into the SF₆ equipment. This method is not selective since it would also respond to moisture and some other deposits would also produce a change in resistance. DE 4133947 describes the use of a sensor that could be installed in the equipment to monitor decomposition product level. The sensor is of the type described in U.S. Pat. No. 4,505,146 (CA 1,201,767).

EP 0484569, Gribi, 13 May 1992, describes the use of a crystal that changes its resonating frequency when exposed to decomposition products. This method is not selective since some metallic deposits may also produce a change in resonant frequency of the crystal.

JP 4711478, 22 Sep. 1967, describes the use of a cation-exchange resin followed by an indicating liquid to detect hydrogen fluoride (HF) and fluorine (F₂). Since both HF and F₂ are extremely reactive, the actual concentrations of these gases may be very low in the decomposition gas. In addition, this is also a wet method that could be very messy to implement.

JP 61285013, 11 Jun. 1985, describes the use of a solid-state device to detect the presence of decomposition product. The junction of the NPN is exposed to the gas and decomposition products containing active fluorine would change the junction properties. However, the change in the junction properties is expected to be permanent and thus, the response of this detector to decomposition products may be cumulative.

JP 1142450, 30 Nov. 1987, describes a sensor constructed by applying silver paste electrodes to the surfaces of glass cloth laminated disc. The sensor lowers its resistance when exposed to decomposition products. The change in resistance in this sensor may be cumulative and permanent.

JP 1142452, 30 Nov. 1987, describes a sensor constructed by applying silver paste electrodes to the surfaces of an epoxy resin disc impregnated with inorganic silicon compound. The change in resistance in this sensor may be cumulative and permanent.

JP 1142453, 30 Nov. 1987, describes a sensor constructed by applying silver paste electrodes to the surfaces of a silicon rubber disc impregnated with a silica powder. The change in resistance in this sensor may be cumulative and permanent.

Instruments based on ion mobility spectrometry can also be used to detect decomposition products, for example, from G.A.S. Gesellschaft für analytische Sensorsysteme. However, the equipment is costly and the interpretation of the results is not simple.

The use of indicator tubes is the most widely field chemical method used today. In practice, a quantity of the sample gas is introduced into a sample chamber. This sample gas is released into the indicator tube at a manually controlled rate. The presence of SOF₂ and SO₂ is indicated by a color change in the indicator tube with graduation marks. These tubes are not specific to the predominant SF₆ decomposition product, SOF₂, which has a limited shelf life. The measurement is not in real time and is not very accurate. This process is manual and the results are subject to operator errors.

The other commonly used method is to send a sample of the SF₆ to a qualified laboratory to perform trace analyze for the presence of SOF₂. A sample of the gas is withdrawn from the suspect equipment into a stainless steel sample cylinder. Depending on the distance of the lab from the equipment, the delay could be weeks. Because of sample degradation, and potential for contamination during sampling, the results of the analysis may be inaccurate and usually lower than actual.

There is a strong need in the utility industry for a portable instrument that:
Detects SOF₂ in the field and in real time,
Can be used on energized equipment,
Provides a detection limit at the part per million (ppm) level,
Is easy to operate with minimal operator intervention.

### SUMMARY OF THE INVENTION

The invention is directed to an apparatus for detecting SF₆ decomposition products comprising: (a) an inlet for receiving SF₆ gas containing SOF₂, SF₄ and other SF₆ decomposition products; (b) a chamber connected to the inlet and containing a catalyst which converts SOF₂ and SF₄ into SO₂; and (c) an SO₂ detector connected downstream of the chamber.

The apparatus can include a flow control which can be positioned between the inlet and the chamber. The apparatus can include a scrubber which can be connected downstream of the SO₂ detector.

The chamber can be packed with fine silica gel and the scrubber can be packed with molecular sieve. The silica gel can be 100 to 120 mesh size.

The chamber can be heated. The chamber and silica gel can be heated to about 200° C. The chamber can be heated with a DC-AC inverter powered by a rechargeable battery.

The invention is also directed to a process for detecting SF₆ decomposition products comprising passing an SF₆ gas containing SOF₂ or SF₄ through a catalyst which converts SOF₂ and SF₄ into SO₂, and detecting the concentration of SO₂ gas that has been converted.

The process can include a flow control which can regulate the rate of flow of the SF₆ gas.

The process can include scrubbing the gas after the conversion of SOF₂ and SF₄ to SO₂ has taken place. The scrubbing can comprise passing the gas through a molecular sieve.

The catalyst can be fine silica gel. The silica gel can be heated. The silica gel can be heated to about 200° C. The silica gel can be heated with a DC-AC inverter powered by a rechargeable battery.

### BRIEF DESCRIPTION OF DRAWINGS

In drawings which illustrate specific embodiments of the invention, but which should not be construed as restricting the spirit or scope of the invention in any way:

FIG. 1 is a schematic depiction of the SF₆ decomposition products detector according to the invention.

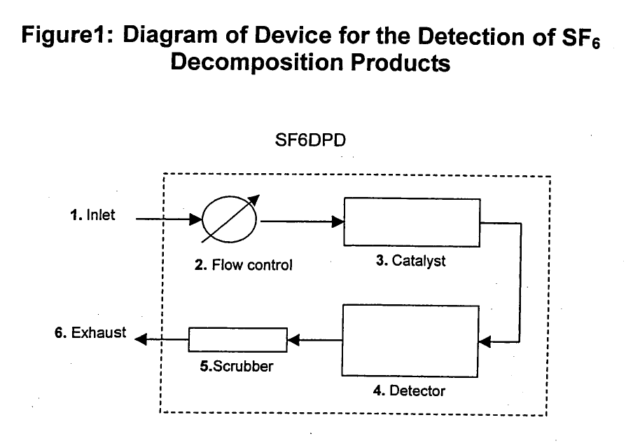

FIG. 2 is a chart showing detector response vs. concentration of SO₂, SF₄, SOF₂, SO₂F₂ and COS.

### DETAILED DESCRIPTION OF THE INVENTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The SF₆ decomposition products detector (SF6DPD) is a portable hand held instrument intended for use by field personnel for the detection and location of SF₆ decomposition products in SF₆ gas filled electrical equipment, and in air. When electrical fault conditions occur, the location of the problem is not always evident. A circuit breaker may trip indicating an electrical fault somewhere in the circuit and the location of this fault requires testing of the separate gas compartments in the circuit.

The SF6DPD allows for fast, real time analysis of SF₆ gas directly from the electrical equipment. The detector has a detection limit of one ppm for the most predominant SF₆ decomposition products thionyl fluoride (SOF₂), sulphur tetrafluoride (SF₄) and sulphur dioxide (SO₂) and limited sensitivity to other decomposition products.

Indicator tubes and laboratory analysis require up to two litres of SF₆ gas for purging and sampling. Since SF₆ is the strongest greenhouse gas known (24,000 times higher Global Warming Potential than CO₂), it is important to minimize the amount of gas vented. The SF6DPD requires about 0.2 litres of gas—an order of magnitude lower than current practice.

It is advantageous to test the gas at the source due to the unstable nature of low-level decomposition products and to detect faults quickly without having to wait for lab analysis. Using a portable detector, rapid screening of equipment is possible to quickly locate problems and minimize outages. Appropriate procedures and precautions can be implemented to ensure hazards to personnel can be minimized prior to maintenance or repair of the equipment.

### Description of a Specific Embodiment of the Invention

The predominant SF₆ secondary decomposition product is SOF₂. It will slowly hydrolyse further into SO₂ and HF in the presence of moisture according to the following reaction:
SOF₂+H₂O=SO₂+HF

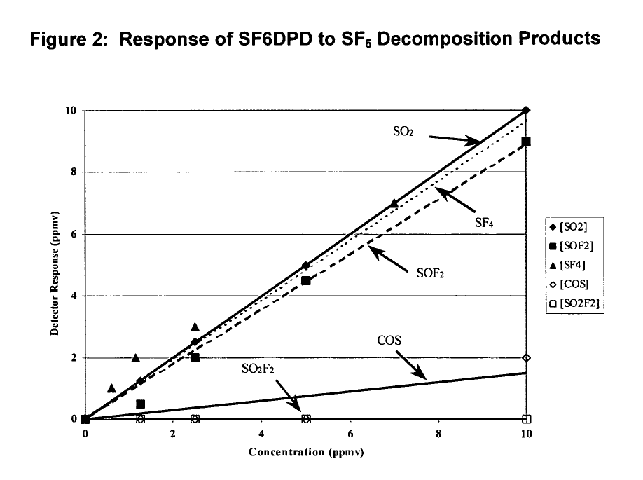

FIG. 2 is a chart showing detector response vs. concentration of SO₂, SF₄, SOF₂, SO₂F₂ and COS. The SF₆ decomposition detector is sensitive to SOF₂, SO₂ and SF₄. The major components of the detector consist of a flow controller, a catalytic reaction tube and a gas detector. The SF₆ gas supply from the equipment to be tested is connected to the inlet line 1. The flow control valve 2 is set to a flow that is optimal for the operation of the catalyst 3 and detector 4. The gas then passes through a scrubber tube 5 and is finally vented to atmosphere through the exhaust tube 6. Nominal flow is 0.4 L per minute.

The sample gas is metered into the heated reaction tube at a flow rate of between 200 and 600 cc/min. The detector has a detection limit of one ppm for SOF₂ (the major decomposition product), and SO₂. The detector has a limited response to COS and no response to SO₂F₂. The detector is able to handle sampling from energized equipment at system pressure. The detector also has a response to SF₄. However, SF₄ is extremely reactive and is rarely a predominant species in decomposition gas mixtures.

The catalyst tube is maintained at an elevated temperature. Nominal operating temperature of the catalyst tube is 200° C. The catalyst tube is in the secondary loop of a DC-AC inverter. A type K thermocouple wire measures the temperature and the amount of heating power is controlled by the use of a high frequency pulse width modulator. This highly efficient energy conversion allows a fast heat up time of less than one minute and the use of a rechargeable battery as power source.

The catalyst tube is made of stainless steel and is packed with fine silica gel of 100-120 mesh size. The catalyst tube converts the SOF₂ and SF₄ into SO₂, which is detected by a commercially available sensor. Suitable commercial SO₂ sensors are available from suppliers such as City Technology, Draeger, Sensidyne and International Sensor Technology, and have a sensitivity at the 1 ppm level.

The scrubber tube is used to remove SO₂ and other reactive gases from the exhaust. The scrubber tube is packed with molecular sieve type 3A. Other materials have also been used successfully, for example, activated alumina and soda lime.

Performance of the Invention

The chart illustrated in FIG. 2 shows the response of the detector to SO₂, SF₄, SOF₂, SO₂F₂ and COS. The response to SO₂, SF₄ and SOF₂ is linear over the ranges of 0-10 ppm. The response of the detector to SO₂F₂ and COS are much lower. Thus, the detector will give a reading that is essentially the total of SO₂, SF₄ and SOF₂.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. An apparatus for detecting SF₆ decomposition products comprising:
(a) an inlet for receiving SF₆ gas containing SOF₂ or SF₄ and other SF₆ decomposition products;
(b) a chamber connected to the inlet and containing a catalyst which converts SOF₂ or SF₄ into SO₂; and
(c) an SO₂ detector connected downstream of the chamber.

2. An apparatus as claimed in claim 1 including a flow control which is positioned between the inlet and the chamber.

3. An apparatus as claimed in claim 1 including a scrubber which is connected downstream of the SO₂ detector.

4. An apparatus as claimed in claim 2 including a scrubber which is connected downstream of the SO₂ detector.

5. An apparatus as claimed in claim 1 wherein the chamber is packed with fine silica gel.

6. An apparatus as claimed in claim 3 wherein the scrubber is packed with molecular sieve.

7. An apparatus as claimed in claim 1 wherein the chamber is heated.

8. An apparatus as claimed in claim 5 wherein the chamber and silica gel are heated to about 200° C.

9. An apparatus as claimed in claim 5 wherein the silica gel is 100 to 120 mesh size.

10. An apparatus as claimed in claim 8 wherein the chamber is heated with a DC-AC inverter powered by a rechargeable battery.

11. A process for detecting SF₆ decomposition products comprising passing an SF₆ gas containing SOF₂ or SF₄ through a catalyst which converts SOF₂ into SO₂, and detecting the concentration of SO₂ gas that has been converted.

12. A process as claimed in claim 11 including a flow control which regulates the rate of flow of the SF₆ gas.

13. A process as claimed in claim 11 including scrubbing the gas after the conversion of SOF₂ and SF₄ to SO₂ has taken place.

14. A process as claimed in claim 11 wherein the catalyst is fine silica gel.

15. A process as claimed in claim 13 wherein the scrubbing comprises passing the gas through a molecular sieve.

16. A process as claimed in claim 14 wherein the silica gel is heated.

17. A process as claimed in claim 16 wherein the silica gel is heated to about 200° C.

18. A process as claimed in claim 17 wherein the silica gel is heated with a DC-AC inverter powered by a rechargeable battery.
